(19) United States
(12) Patent Application Publication
(10) Pub. No.: US 2022/0304324 A1
(43) Pub. Date: Sep. 29, 2022

(54) METHOD FOR PROCESSING A DAIRY PROTEIN COMPOSITION IN ORDER TO PRODUCE A LACTOSE-RICH LIQUID COMPOSITION

(71) Applicant: EURODIA INDUSTRIE, PERTUIS (FR)

(72) Inventors: Florence LUTIN, PERTUIS (FR); Anne GONIN, PERTUIS (FR); Denis LARGETEAU, MAUREPAS (FR)

(21) Appl. No.: 17/702,834

(22) Filed: Mar. 24, 2022

(30) Foreign Application Priority Data
Mar. 25, 2021 (FR) 21 03028

(51) Int. Cl. A23C 9/142; A23J 3/08

(52) U.S. Cl. CPC A23C 9/1425; A23J 3/08

(57) ABSTRACT

A method for the processing a dairy protein composition in order to obtain a lactose-rich liquid composition, including an ultrafiltration step (ii) in order to obtain an ultrafiltration permeate and an ultrafiltration retentate; followed by a processing step (iv) on ion-exchange resins, including at least one pass including percolation over a cationic resin followed by percolation over an anionic resin.

### TECHNICAL FIELD

The present disclosure relates to the field of reclamation of a dairy protein composition, in particular a whey or an ultrafiltration permeate of milk, in order to produce a lactose-rich liquid composition.

### BACKGROUND

The food-processing industry generates significant quantities of by-products annually, which can produce harmful effects on the environment if they are not reclaimed.

Whey is a by-product of the transformation of milk, in particular in the cheese industry, and can be used in animal feed or, if it is not reclaimed, it is thrown away. Today, through the use of various reclamation processes, its use in a plurality of fields has widened considerably. Indeed, whey is sought after as a raw material for its component (proteins, lactose and minerals) and thus represents an opportunity for the production of new products.

Whey (Serum Lactus), commonly called “milk serum”, is a dairy coproduct that results either from coagulation of the milk during cheese production, in particular after separating of the casein and fats during coagulation of the milk, or from a method for membrane filtration of milk, such as milk microfiltration. It is the liquid portion. The solid portion is called curds. It is watery, translucent and characterised by a greenish yellow colour.

There are three types of whey: those originating from the production in acid medium of caseins or fresh cheeses (acid whey); those originating from casein production using a rennet and hard or semi-hard pressed cheeses (sweet whey); and those originating from microfiltration of milk, termed ideal or native whey, (this is the microfiltration permeate of milk). Whey is mainly formed of water, lactose, proteins, in particular serum proteins, and minerals. Whey can be reclaimed by isolating the lactose and proteins. Whey proteins can also be reclaimed as an ingredient for the production of many food products, for example for the production of nutritional and protein beverages.

It is known to process non-demineralised whey by ultrafiltration (UF) in order to produce whey protein concentrates (WPC) originating from the ultrafiltration retentate. The ultrafiltration permeates themselves are used in animal feed, in methanisation or in a whey plant. These permeates, low in proteins, rich in lactose and in minerals, are difficult to reclaim. The production costs of these UF permeates are often supported by the high added value of its coproduct, the non-demineralised WPC.

There is thus a need to improve the reclamation of milk by-products, in particular whey or milk ultrafiltration permeates, in particular by developing novel outlets and by tuning efficient processing methods generating little effluent to be treated, because the compounds of interest are reclaimed to the maximum.

### SUMMARY

The present disclosure relates, according to a first aspect, to a method for processing a dairy protein composition in order to obtain a lactose-rich liquid composition addressing the above-cited problems, and including the steps:
(i)—providing a dairy protein composition;
(ii)—ultrafiltration of the dairy protein composition in order to obtain an ultrafiltration permeate and an ultrafiltration retentate;
(iii)—a step of at least partial demineralisation, taking place before ultrafiltration step (ii) and/or after ultrafiltration step (ii);
(iv)—at least one step of processing, on ion-exchange resins, the at least partially demineralised ultrafiltration permeate, having at least one pass including percolation over a cationic resin followed by percolation over an anionic resin.

Advantageously, during the passage of the dairy protein composition in the ultrafiltration unit, the serum proteins are retained in the ultrafiltration retentate and are thus concentrated in this retentate while water and the low molecular weight molecules in solution pass through the ultrafiltration membrane or membranes. The permeation of minerals is not equivalent to the permeation of lactose. Indeed, certain minerals are bonded to the serum proteins and consequently retained in the retentate.

We understand in the present text by “percolation on a determined resin followed by percolation on another determined resin” that the two percolations follow one another directly without demineralization intermediary step taking place between the two percolations.

The combination of the steps of ultrafiltration (ii), demineralisation (iii) and at least one pass over ion-exchange resins during step (iv) enables a demineralised lactose-rich liquid composition to be obtained from the dairy protein composition of step (i).

The present disclosure makes it possible to obtain a lactose-rich liquid composition, in particular with a dry mass fraction of lactose greater than or equal to 90%.

For dry mass fractions of lactose greater than or equal to 90%, in particular greater than or equal to 95%, this is a liquid lactose.

Lactose exists in the prior art in solid form (for example as a powder) and is obtained after processing, in a whey plant, a liquid composition including dry mass fractions of lactose that are lower than those obtained in the present disclosure

The presentation of lactose in liquid form is novel. This form has many advantages for its use, in particular for the formulation of dairy products. Moreover, this frees manufacturers using the dairy protein composition (i) from using a whey plant that is expensive and complex to use.

The lactose obtained by means of the method according to the disclosure can be reclaimed in liquid or solid form (by implementing a step of evaporating the water and drying).

### Demineralisation Step (iii)

The demineralisation step (iii) can be any demineralisation step known to a person skilled in the art enabling a reduction in the conductivity (μsiemens/cm) and/or the dry mass fraction of minerals and/or ash: of the dairy protein composition (i) before ultrafiltration step (ii), and/or of the ultrafiltration permeate (ii) before step iv) of processing on the ion-exchange resins. The intensity of this demineralisation is a function of the dry mass fraction of minerals of the dairy protein composition at step (i).

This demineralisation step (iii) can take place before UF step (ii) in order to at least partially demineralise the dairy protein composition at the inlet to UF step (ii), and/or after UF step (ii) in order to at least partially demineralise the ultrafiltration permeate at the inlet to step (iv) including at least one pass over ion-exchange resins.

Finally, the ultrafiltration permeate must be strongly demineralised at the inlet to step (iv) on the ion-exchange resins in order to increase the dry mass fraction of lactose in the resulting lactose-rich liquid composition. This demineralisation step can be carried out in a non-limiting manner as described in the present text or again as described in patent EP 1.053.685 B1 or in WO 2020/207894.

Lactose-rich liquid composition obtained shall be understood to mean the composition recovered/collected at the outlet of step iv), or after a decolouration step described below or a step v) described below in order to remove, in particular, galactose.

The temperature of the dairy protein composition in step (i) and/or at the inlet to step (ii) and/or of the UF permeate obtained in step (ii) and/or the UF retentate obtained in step (ii) and/or the UF permeate in step iv) and/or the lactose-rich liquid composition obtained is preferably higher than 0° C., more particularly lower than or equal to 40° C., still more particularly lower than or equal to 30° C., in particular lower than or equal to 20° C.

The ultrafiltration step (ii) and/or the demineralisation step (iii) and/or the step (iv) on the ion-exchange resins is/are preferably carried out (i.e so as to maintain the processed product) at a temperature higher than 0° C., more particularly lower than or equal to 40° C., still more particularly lower than or equal to 30° C., in particular lower than or equal to 20° C.

### Dairy Protein Composition

The dairy protein composition of step (i) can be chosen among, in particular is chosen from the list including of: milk, in particular skimmed milk, whey, and a mixture thereof, optionally partially demineralised.

The whey according to the disclosure can be chosen among, in particular is chosen from the list including of: a sweet whey; an acid whey; an ideal or native whey, in particular a microfiltration permeate of milk; and a mixture thereof.

A sweet whey can be obtained by a physiochemical processing of milk (for example precipitation and/or coagulation), in particular using rennet, enabling the caseins as well as the sweet whey to be recovered.

An ideal or native whey can be obtained by physical membrane processing of the milk, in particular using a microfiltration or ultrafiltration, enabling the casein and an ideal whey to be recovered.

An acid whey is preferably obtained by acid processing of the milk, in particular using a lactic acid and/or hydrochloric acid, allowing the caseins as well as the acid whey to be recovered.

In an embodiment, DPC in step (i) is milk, or a sweet whey, or an ideal or native whey, or an acid whey.

In an embodiment, DPC in step (i) is milk, and the method includes a demineralization step (iii), in particular according to one of the embodiments as described in the present text, carried out on the milk ultrafiltration permeate after step (ii).

We understand in the present text by diary protein composition obtained after a demineralization step (iii) carried out after the UF step (ii), an ultrafiltration permeate of the DPC in step (i), the permeate having undergone the demineralization step (iii).

The dairy protein composition in step (i), or the dairy protein composition before or after a demineralisation step (iii) carried out before or after the UF step (ii), can be pre-concentrated in order to increase its total dry mass fraction, either mechanically (for example by reverse osmosis or nanofiltration or a combination thereof) and/or thermally (for example by evaporation of water).

The dairy protein composition in step (i) can be partially demineralised or otherwise, in other words raw.

The demineralisation step (iii) can thus be a first demineralisation when the dairy protein composition of step (i) has not undergone demineralisation beforehand, or a second or nth demineralisation step when the dairy protein composition of step (i) has already been partially demineralised.

In an embodiment, the dairy protein composition in step (i), preferably obtained after a demineralisation step (iii) carried out before or after UF step (ii), has a mass fraction of ash, calculated with respect to the total dry mass of the dairy protein composition, greater than 0% and less than or equal to 6%, preferably less than or equal to approximately 2.5%.

In an embodiment, the dairy protein composition in step (i), or obtained after a demineralisation step (iii) carried out before or after UF step (ii), has a dry extract greater than or equal to 5% and less than or equal to 35%, more preferably greater than or equal to 10% and less than or equal to 30%.

The dairy protein composition in step (i) is liquid during its use. It can be obtained by reconstituting a liquid solution based on powder(s) and/or mixed liquid(s), for example by dispersion in water of an optionally partially demineralised whey powder, or an optionally partially demineralised and skimmed milk powder and the mixtures thereof.

In an embodiment, the dairy protein composition in step (i), preferably obtained after a demineralisation step (iii) carried out before or after UF step (ii), has a level of demineralisation greater than or equal to 70%, more preferably greater than or equal to 80%, preferentially greater than or equal to 85%, in particular greater than or equal to 90%.

In general, the dairy protein composition originates from milk, which milk can come from any dairy female.

Preferably, the dairy protein composition originates from a milk chosen from: cow's milk, goat's milk, sheep's milk, donkey milk, buffalo milk, mare's milk, camel's milk and a mixture thereof, more preferably chosen from: cow's milk, goat's milk and sheep's milk and a mixture thereof, in particular it is cow's milk.

The whey includes serum proteins, and preferably does not include residual caseins in the portion solidified (coagulated) during the transformation of the milk and/or in the microfiltration retentate of the milk.

In an embodiment, the dairy protein composition in step (i), or obtained after a demineralisation step (iii) carried out before or after UF step (ii), is a whey for which the ratio of lactose dry mass over the total dry mass of the whey, is greater than or equal to 50%, preferably greater than or equal to 60%, more preferably greater than or equal to 70%, preferentially greater than or equal to 80%, in particular greater than or equal to 85%.

In an embodiment, the dairy protein composition in step (i), or obtained after a demineralisation step (iii) carried out before or after UF step (ii), is a whey for which the ratio of lactose dry mass over the total dry mass of the whey, is less than or equal to 90%.

In an embodiment, the dairy protein composition in step (i), or obtained after a demineralisation step (iii) carried out before or after UF step (ii), is a whey for which the ratio of dry mass of the total nitrogenous matter (TNM) over the total dry mass of the whey, is greater than 0%, preferably greater than or equal to 1%, more preferably greater than or equal to 3%, preferentially greater than or equal to 5%.

In an embodiment, the dairy protein composition in step (i), or obtained after a demineralisation step (iii) carried out before or after UF step (ii), is a whey for which the ratio of dry mass of the total nitrogenous matter (TNM) over the total dry mass of the whey, is less than or equal to 30%, preferably less than or equal to 25%, preferentially less than or equal to 20%.

Preferably, the dairy protein composition in step i), or obtained after a demineralisation step (iii) carried out before or after the UF step (ii), has a conductivity greater than or equal to 0.10 mS/cm, preferably greater than or equal to 0.80 mS/cm, more preferably less than or equal to 15 mS/cm.

Preferably, the dairy protein composition in step (i), or at the inlet of UF step (ii), includes the following cations: calcium, magnesium, sodium, potassium.

Preferably, the dairy protein composition in step (i), or at the inlet to UF step (ii), includes the following anions: chloride, phosphate, sulfate, lactate and citrate, which are in particular the anions targeted by the demineralisation method according to the disclosure.

In the present text, dairy protein composition at the inlet to UF step (ii) designates a dairy protein composition having optionally undergone a demineralisation step (iii).

### Sweet Whey/Native Whey

In an embodiment, the dairy protein composition in step (i) is a sweet whey or a native whey or a mixture thereof, optionally at least partially demineralised (for example, during a step (iii) before ultrafiltration step (ii)), or a milk ultrafiltration step in step (ii), which has one of the following properties, alone or in combination:
a pH between 4.7 and 6.9;
the ratio of the dry mass of lactose over the total dry mass of sweet whey, or of native whey, is greater than or equal to 70% or 80%, in particular less than or equal to 90% or 85%;
the ratio of the dry mass of total nitrogenous matter (TNM) over the total dry mass of sweet whey, or of native whey, is greater than or equal to 10%, preferably greater than or equal to 12%, in particular less than or equal to 20%;
the ratio of the dry mass of ash over the total dry mass of sweet whey, or of native whey, is greater than or equal to 0.1%, in particular greater than or equal to 0.3%,
when the sweet or native whey is partially demineralised, the ratio of the dry mass of ash over the total dry mass of sweet or native whey is less than or equal to 4% or 3%, or
the ratio of the dry mass of ash over the total dry mass of the sweet or native whey is greater than or equal to 5%, in particular greater than or equal to 7%, in particular less than or equal to 13% (when the sweet or native whey is not demineralised).

### Acid Whey

In an embodiment, the dairy protein composition in step (i) is an acid whey, optionally at least partially demineralised (for example, during a step (iii) before ultrafiltration step (ii)), which has one of the following properties, alone or in combination:
a pH lower than or equal to 6.5, in particular more than or equal to 4, more particularly lower than or equal to 6.1;
the ratio of the dry mass of lactose over the total dry mass of the acid whey is greater than or equal to 50% or 60% or 70% or 80%, in particular less than or equal to 90%, in particular less than or equal to 85%, for example is a whey originating from the production of cheeses in an acid medium of cheeses or of casein in an acid medium;
the ratio of the dry mass of the total nitrogenous matter (TNM) over the total dry mass of acid whey is greater than or equal to 5%, in particular less than or equal to 20%, in particular less than or equal to 15%;
when the acid whey is at least partially demineralised, the ratio of the dry mass of ash over the total dry mass of the acid whey is greater than or equal to 1.5%, in particular less than or equal to 5%, or
the ratio of the dry mass of ash over the total dry mass of acid whey is greater than or equal to 5%, in particular greater than or equal to 7%, in particular less than or equal to 13% (when the acid whey is not demineralised).

### Ultrafiltration Step (ii)

Advantageously, the ultrafiltration of a whey, in particular a whey which is partially demineralised, increases the mass fraction of lactose in the permeate. Moreover, the mass fraction of ash of the ultrafiltration retentate obtained in step (ii) is close to that of a whey protein isolate (WPI).

Advantageously, it is observed that the mass fractions of calcium and of phosphorus calculated with respect to the total dry mass of the UF retentate of an at least partially demineralised whey, are reduced. This provision makes it possible to limit, or even remove, the precipitation of calcium phosphate or proteins on the membranes in the course of concentration during step (ii).

Advantageously, the proteins are thermally stabilised in the ultrafiltration retentate through the prior extraction of calcium during demineralisation step (iii) having taken place before step (ii).

These effects are advantageous because the ash and organic acids can be problematic for the subsequent use of whey protein concentrates and for fouling of the ultrafiltration membranes over time.

Moreover, the permeation flows are improved and the production times are optimised with respect to the cleaning time.

In an embodiment, the ratio of the dry mass of lactose over the total dry mass of the ultrafiltration permeate obtained in step (ii), or after a demineralisation step (iii) carried out after step (ii) on the UF permeate (ii), is greater than or equal to 50%, preferably greater than or equal to 60%, more preferably greater than or equal to 70%, preferentially greater than or equal to 75% or 80%, more preferentially greater than or equal to 85% or 90%.

In an embodiment, the ratio of the dry mass of lactose over the total dry mass of the ultrafiltration permeate obtained in step (ii), or after a demineralisation step (iii) carried out after step (ii) on the UF permeate (ii), is less than or equal to 96%.

In another embodiment, the ratio of the dry mass of lactose over the total dry mass of the ultrafiltration permeate obtained in step (ii), or after a demineralisation step (iii) carried out after step (ii) on the UF permeate (ii), is greater than or equal to 96%.

In an embodiment, the ratio of the dry mass of total nitrogenous matter (TNM) over the total dry mass of the ultrafiltration permeate obtained in step (ii), or after a demineralisation step (iii) carried out after step (ii) on the UF permeate (ii), is greater than or equal to 0%, preferably greater than or equal to 1%, more preferably greater than or equal to 3%.

In an embodiment, the ratio of the dry mass of total nitrogenous matter (TNM) over the total dry mass of the ultrafiltration permeate obtained in step (ii), or after a demineralisation step (iii) carried out after step (ii) on the UF permeate (ii), is less than or equal to 20%, preferably less than or equal to 15%, more preferably less than or equal to 10%, preferentially less than or equal to 5%.

In an embodiment, the ultrafiltration permeate obtained in step (ii), or after a demineralisation step (iii) carried out after step (ii) on the UF permeate (ii), has a level of demineralisation greater than or equal to 70%, in particular greater than or equal to 75%, particularly greater than or equal to 80%, more particularly greater than or equal to 85%.

In an embodiment, the ultrafiltration permeate obtained in step (ii), or after a demineralisation step (iii) carried out after step (ii) on the UF permeate (ii), has a level of demineralisation greater than or equal to 90%, in particular greater than or equal to 95%.

In an embodiment, the ratio of the dry mass of ash over the total dry mass of the ultrafiltration permeate obtained in step (ii), or after a demineralisation step (iii) carried out after step (ii) on the UF permeate (ii), is greater than or equal to 0.1%, in particular greater than or equal to 0.3%.

In an embodiment, the ratio of the dry mass of ash over the total dry mass of the ultrafiltration permeate obtained in step (ii), or after a demineralisation step (iii) carried out after step (ii) on the UF permeate (ii), particularly at the inlet to step (iv), is less than or equal to 4%, preferably less than or equal to 2.5%, more preferably less than or equal to 2, even more preferably less than or equal to 1%.

In the present text, UF permeates (ii) at the inlet to step (iv) of passage over the ion-exchange resins, shall designate a UF permeate optionally having undergone a demineralisation step (iii).

In an embodiment, the conductivity of the ultrafiltration permeate obtained in step (ii), or after a demineralization step (iii) carried out after step (ii) on the UF permeate (ii), particularly at the inlet to step (iv), is less than or equal to 3 mS/cm.

The UF permeate of step (ii) can be mechanically preconcentrated (for example by reverse osmosis or nanofiltration or a combination thereof) and/or thermally preconcentrated for example by evaporation of water). This concentration step increases the content by mass of dry matter and can be performed before or after a demineralisation step (iii) carried out after step (ii).

### Step (iv) on Ion-Exchange Resins

Advantageously, step iv) including at least one pass over ion-exchange resins, enables the demineralisation and optionally deacidification of the ultrafiltration permeate of step ii). This step iv) also removes the residual nitrogenous matter.

Step iv) also increases the dry mass fraction of lactose in the UF permeate originating from ultrafiltration step ii). If this UF permeate is not demineralised or is only insufficiently demineralised, it is necessary to perform a demineralisation step (iii) after step iv).

The percolation over a cationic resin also acidifies the UF permeate (ii), preferably before its passage over an anionic resin which raises the pH of the permeate.

The percolation over a cationic resin is advantageously a cationic substitution step, in particular of divalent and/or monovalent cations by hydrogen ions H⁺. In particular, this step is an acidification step (in other words the pH of the UF permeate (ii) is lowered following its passage over the cationic resin).

The percolation over an anionic resin is advantageously an anionic substitution step, in particular of divalent and/or monovalent anions by hydroxyl ions, in particular this step is a neutralisation step (in other words the pH of the UF permeate (ii) is raised following its passage over the anionic resin).

The cationic resin during step (iv) can be strong or weak.

The anionic resin during step (iv) can be strong or weak.

Preferably, the percolation over a cationic resin is carried out without the latter being mixed with an anionic resin.

Preferably, the percolation over an anionic resin is carried out without the latter being mixed with a cationic resin.

In the present text, percolation over a cationic or anionic resin is understood to mean percolation over at least one column including a cationic or anionic resin, preferably the processing, in particular the circulation, of the product to be processed over a bed of particles (in particular beads) including a cationic or anionic resin.

In a preferred embodiment, step (iv) of processing, on ion-exchange resins, the at least partially demineralised ultrafiltration permeate, includes at least one pass including percolation over a strong cationic resin followed by percolation over a weak anionic resin.

In particular, weak or strong anionic resin raises the pH of the ultrafiltration permeate when the latter is acid before its passage over the weak or strong anionic resin.

The strong cationic resin preferably includes sulfonate groups SO₃⁻.

The strong cationic resin in the form of H⁺, fixes the cations bonded to the strong or weak anions.

A weak cationic resin in the form of H⁺ can only fix the cations bonded to weak acids.

The, in particular strong, cationic resin preferably has an exchange capability greater than or equal to 1.8 eq/litre.

The bed of, in particular strong, cationic resin, in particular of strong cationic styrene resin, preferably includes beads, the size of which is greater than or equal to 0.45 mm.

The bed of, in particular weak, anionic resin, in particular of weak anionic styrene resin, preferably includes beads, the size of which is greater than or equal to 0.40 mm.

The, in particular weak, anionic resin preferably has an exchange capability greater than or equal to 1.6 eq/litre.

Preferably, the mass content of water of at least one column of, in particular weak, anionic resin, or at least one column of, in particular strong, cationic resin, is less than or equal to 65%, in particular less than or equal to 60%.

The strong cationic resin during the first pass, and optionally during the second pass and/or the subsequent pass or passes, is preferably a strong cationic resin with high porosity.

The weak anionic resin preferably includes tertiary amine groups, in particular for fixing anions in solution with acid pH. By contrast, a strong anionic resin fixes anions in solution whatever the pH of the solution.

The weak anionic resin during the first pass, and optionally during the second pass and/or the subsequent pass or passes, is preferably a weak anionic resin with high porosity.

### Lactose-Rich Liquid Composition Obtained According to the Method of the Disclosure

In an embodiment, the ratio of the total dry mass of sugar(s) over the total dry mass of the lactose-rich liquid composition obtained is greater than or equal to 90%, preferably greater than or equal to 95%, more preferably greater than or equal to 98%, in particular greater than or equal to 99%.

In an embodiment, the sugar is lactose.

In the present text, sugar(s) is understood to mean milk monosaccharides and milk polysaccharides, in particular lactose and galactose.

In the present text, the polysaccharides include disaccharides and oligosaccha rides.

In an embodiment, the sugar(s) is/are monosaccharide(s) and/or polysaccharide(s) that is/are ionically uncharged.

In an embodiment, the ratio of the total dry mass of total nitrogenous matter over the total dry mass of the lactose-rich liquid composition obtained is less than or equal to 5%, preferably less than or equal to 3%, more preferably less than or equal to 1%, in particular less than or equal to 0.5%.

In an embodiment, the ratio of the dry mass of glycomacropeptide(s) over the total dry mass of the lactose-rich liquid composition obtained is less than or equal to 2%, preferably less than or equal to 0.5%, more preferably less than or equal to 0.1%, in particular less than or equal to 0.5%.

In an embodiment, the lactose-rich liquid composition obtained has a level of demineralisation greater than or equal to 90%, preferably greater than or equal to 95%, in particular greater than or equal to 96%, or 97%, or 98%, or 99%.

In an embodiment, the ratio of the total dry mass of the lactose-rich liquid composition obtained over the total mass of the lactose-rich liquid composition is greater than 0%, preferably greater than or equal to 5%, more preferably greater than or equal to 10%.

In an embodiment, the ratio of the total dry mass of the lactose-rich liquid composition obtained over the total mass of the lactose-rich liquid composition is less than or equal to 30%, preferably less than or equal to 25%, more preferably less than or equal to 20%.

The lactose-rich liquid composition preferably includes water, in particular the mass fraction of which with respect to its total mass is between 70% and 95%.

### Definitions—Measurement Methods

The mass content of ash (or dry mass fraction of ash), in particular of the dairy protein composition in step (i), optionally after a demineralisation step (iii), of the UF retentate (ii), or of the UF permeate (ii), optionally after a demineralisation step (iii), or of the lactose-rich liquid composition obtained, can be determined using the standardised method NF VO4-208 Oct. 1989, entitled “Milk. Determination of ash. Reference method”, in particular implementing a method of incineration at 525° C.

In the present text, dry extract by mass or total dry mass, is understood to mean the dry mass, for example, of the dairy protein composition, of the UF retentate (ii), or of the UF permeate, or the dry mass of the lactose-rich liquid composition, obtained after evaporation of water until a stable total dry mass is obtained relative to the total mass of the dairy protein composition, of the UF retentate (ii), or of the UF permeate or of the lactose-rich liquid composition, in particular at atmospheric pressure. The dry extract by mass can be determined using the standardised method ISO 6731: Jan. 2011, “Milk, Cream and evaporated milk—Determination of the total solids content (Reference method)”.

In the present text, lactose is understood to mean lactose as defined in the Codex Alimentarius, Codex Stan 212-1999: a natural constituent of milk normally obtained from whey, in particular with an anhydrous lactose content of not less than 99.0%

mass/mass on a dry basis.

The determination of the mass content of lactose or of sugar (or dry mass fraction) can be carried out by high-performance liquid chromatography, in particular using standard NF ISO 22662, dated Nov. 2007.

The method which can be used in order to quantify the cations and anions of milk (calcium, magnesium, sodium, potassium, phosphorus/phosphate, citrate) can be chosen among the following methods: molecular absorption spectrometry, titrimetric/complexometric method, electrochemical method, atomic spectrometry, capillary electrophoresis, ionic chromatography/conductimetric detection, nuclear magnetic resonance for ³¹P, enzymatic method/UV detection.

The dry mass fraction of total nitrogenous matter (TNM) can be determined using standard NF EN ISO 8968-1 dated May 2014 (Kjeldhal method).

The following standards can be used to determine the mass content: for example of chlorides: potentiometric titration method (NF ISO 21422, Feb. 2019); for example of total phosphorus: molecular absorption spectrometry method (NF ISO 9874, Apr. 2008); for example of calcium: titrimetric method (standard ISO 12081:2010); for example of calcium, sodium potassium and magnesium: atomic absorption spectrometry method (standard ISO 8070:2007) or ionic chromatography; for example of lactic acid/lactate via the standard ISO 8069 dated 2005.

In the present text, DPC designates the dairy protein composition according to the disclosure.

In the present text UF designates an ultrafiltration.

In the present text, level of demineralisation is understood to mean the level of reduction of mass of minerals (including the cations and anions) measured on the basis of the formula: ((dry mass fraction of ash or of minerals of the non-demineralised DPC—the content by mass of ash or minerals of the at least partially demineralised target DPC)/content of ash of the non-demineralised DPC)*100).

The level of demineralisation can also be evaluated by replacing the dry mass fraction of minerals or ash by a conductivity measurement (mS/cm). These calculation methods also apply to the UF permeate, to the UF retentate and to the lactose-rich liquid composition obtained.

In the present text, a dry mass fraction in one or more given component is calculated with respect to the total dry mass of the liquid composition including the or the components.

In a first alternative, step iv) includes at least two passes.

This provision is optimum for increasing the dry mass fraction of lactose, lowering the ash and/or mineral content and removing the remaining nitrogenous matter.

In a second alternative, the ultrafiltration step (ii) includes the use of one or more ultrafiltration membranes, each having a minimum cut-off threshold greater than or equal to approximately 1000 Daltons, preferably greater than or equal to approximately 3000 Daltons, more preferably greater than or equal to 4000 Daltons.

The ultrafiltration step (ii) preferably includes the use of one or more ultrafiltration membranes, each having a minimum cut-off threshold less than or equal to approximately 10,000 Daltons, preferably less than or equal to approximately 8000 Daltons, more preferably less than or equal to 7000 Daltons, preferentially less than or equal to 6000 Daltons.

The inventors have discovered that the use of such membranes in ultrafiltration under the conditions of the present disclosure enables more of the nitrogenous matter to be retained in the retentate and thus removing it from the permeate, and avoids leakage of true proteins, in particular avoids leakage of glycomacropeptides (GMP) which increases the saturation capacity of the resins used downstream in step (iv).

In a third alternative embodiment, the dairy protein composition at the inlet to ultrafiltration step ii) has a level of demineralisation greater than or equal to 70%, preferably greater than or equal to 75%, more preferably greater than or equal to 80%, preferentially greater than or equal to 85% or 90%.

In an embodiment, the dairy protein composition (i) is a whey and the method includes at least one demineralisation step (iii) taking place before UF step (ii) in order to at least partially demineralise the dairy protein composition (i) until the targeted demineralisation level is reached.

In this embodiment, the method preferably does not include demineralisation step (iii) taking place after UF step (ii) and before step (iv). The demineralisation upstream of the ultrafiltration is sufficiently advanced so that the combined UF step (ii) and percolation over resins in step (iv) makes it possible to obtain a dry mass fraction of lactose between 90% and 100%, in particular between 95% and 100%.

In a fourth alternative embodiment, the ultrafiltration permeate at the inlet to step (iv) of processing on resins has a level of demineralisation greater than or equal to 80%, preferably greater than or equal to 85%, more preferably greater than or equal to 90%.

The demineralisation must be sufficient before passage over the resins in order that these do not saturate too quickly and that the resins enable the already initiated demineralisation to be completed and increases the dry mass fraction of lactose.

In an embodiment, the dairy protein composition of step (i) is milk or an optionally non-demineralised whey, and the method includes a demineralisation step (iii) carried out after ultrafiltration step (ii) in order to demineralise the UF permeate until the targeted level of demineralisation is reached.

In a fifth embodiment, the at least partial demineralisation step (iii) includes a step (iiia) of substituting cations by hydrogen ions H⁺.

This provision lowers the pH of the dairy protein composition or of the UF permeate of step (ii), in particular to a pH between 2 and 4, more particularly to a pH between 2 and 3 (upper and lower limits included).

The lowering of the pH and the demineralisation facilitate one or more optional steps of nanofiltration and/or electrodialysis downstream, by improving their yield and stabilising the composition to be processed.

The substituted cations can be divalent cations and/or monovalent cations.

In an embodiment, the step of exchanging cations (iiia) by hydrogen ions H⁺, includes at least one percolation of the dairy protein composition of step (i) or of the UF permeate of step (ii) over at least one column including a cationic resin, in particular a weak or carboxylic cationic resin. The cationic resin can be strong or weak, in particular it is a weak cationic resin.

In an embodiment, the demineralisation step (iii) includes, in particular downstream of step (iiia), a step of substituting anions (iiib) by hydroxyl or chloride ions.

The substituted anions can be divalent anions and/or monovalent anions. In an embodiment, the step (iiib) of exchanging anions by chloride ions includes, in particular downstream of step (iiia) employing a cationic resin, in particular a weak or carboxylic cationic resin, at least one step of percolation of the dairy protein composition of step (i) or of the UF permeate of step (ii) over at least one column including an, in particular strong, anionic resin, optionally mixed with an, in particular strong, cationic resin (in other words with mixed beds).

In a sixth embodiment, the step (iiia) of substituting cations is an electrodialysis step of, in particular exclusively, cationic substitution carried out on an electrodialyser having cells each including three compartments.

The dairy protein composition (i) or the UF permeate (ii) preferably circulates in one compartment, in particular the central compartment, delimited between two cationic membranes.

In a seventh embodiment, the demineralisation step (iii) includes a step (iiib) of substituting, in particular exclusively, anions by hydroxyl ions, and the step (iiib) is carried out on an electrodialyser having cells each including three compartments.

The step (iiib) is preferably carried out after step (iiia).

The dairy protein composition (i) or the UF permeate (ii) preferably circulates in one compartment, in particular the central compartment, delimited between two anionic membranes.

In an embodiment, the demineralisation step (iii) includes:
a step (iiia) of substitution, in particular exclusively, of cations by hydrogen ions H⁺, in particular an electrodialysis step of cationic substitution carried out on an electrodialyser having cells each including three compartments; then
optionally an electrodialysis step, in particular for extracting anions and cations, carried out on an electrodialyser the cells of which include two compartments; then
a step (iiib) of substitution, in particular exclusively, of anions by hydroxyl ions, the step (iiib) is carried out on an electrodialyser having cells each including three compartments.

In an eighth embodiment, the at least partial demineralisation step (iii) includes an electrodialysis step and/or a nanofiltration step, in particular carried out after step (iiia) and/or after step (iiib).

This electrodialysis step advantageously enables the extraction of anions and cations.

The choice between the electrodialysis step and/or the nanofiltration step is preferably made according to the dry mass extract of the dairy protein composition in step (i) or of the UF permeate in step (ii).

In an embodiment, the demineralisation step includes a step of nanofiltration when the dry mass extract of the dairy protein composition or of the UF permeate is less than or equal to 15%.

In an embodiment, demineralisation step (iii) includes, preferably only, an electrodialysis step carried out, in particular, on an electrodialyser, the cells of which include two compartments, more preferably carried out after ultrafiltration step (ii).

In an embodiment, demineralisation step (iii) includes an electrodialysis step, in particular carried out on an electrodialyser, the cells of which include two compartments, after step (iiia) of substituting cations by hydrogen ions H⁺, preferably the step of substituting, in particular exclusively, cations (iiia) is an electrodialysis step of cationic substitution carried out on an electrodialyser having cells each including three compartments. The dairy protein composition (i) or the UF permeate (ii) preferably circulates in one compartment, in particular the central compartment, delimited between two cationic membranes.

In an embodiment, the demineralisation step (iii) includes an electrodialysis step, in particular carried out on an electrodialyser, the cells of which include two compartments, after step (iiia) of substituting cations by hydrogen ions H⁺, and after step iiib) of substituting, in particular exclusively, anions). Steps iiia) and iiib) are preferably percolation steps on ion-exchange resins, such as described above.

The step of substituting anions (iiib), in particular exclusively, can be carried out, as described above, on ion-exchange resins or on an electrodialyser, the cells of which each include three compartments.

The step (iiia) of substituting cations, in particular exclusively, can be carried out, as described above, on ion-exchange resins or on an electrodialyser, the cells of which each include three compartments.

In an embodiment, the demineralisation step (iii) includes at least on pass including percolation of the DPC of the step (i), or of the permeate obtained with ultrafiltration of the CPL of step (i), on a weak cationic resin, followed by a nanofiltration step, and then an electrodialysis step carried out onto the nanofiltration retentate, in particular, on an electrodialyser, the cells of which include two compartments.

Preferably, the DCP in step (i) is a sweet whey having a dry matter higher than or equal to 5.5%, more preferably the step (iii) is carried out before the UF (ii) and onto DCP (i).

Advantageously, this step (iii) enables to reach a demineralization rate higher than or equal to 70%.

In an embodiment, the demineralisation step (iii) includes a nanofiltration step of the DPC of the step (i), or of the permeate obtained with ultrafiltration of the CPL of step (i), then an electrodialysis step carried out onto the nanofiltration retentate, in particular, on an electrodialyser, the cells of which include two compartments.

Preferably, the DCP in step (i) is an acid whey having a dry matter higher than or equal to 5.5%, more preferably the step (iii) is carried out before the UF (ii) and onto DCP (i).

Advantageously, this step (iii) enables to reach a demineralization rate higher than or equal to 70%.

In an embodiment, the demineralisation step (iii) includes at least on pass including percolation of the DPC of the step (i), or of the permeate obtained with ultrafiltration of the CPL of step (i), on a weak cationic resin, followed by percolation on a mixed bed of a strong cationic resin with a strong anionic resin, followed by a nanofiltration step, and then an electrodialysis step carried out onto the nanofiltration step, in particular, on an electrodialyser, the cells of which include two compartments, and finally the step (iii) includes a percolation on a anionic resin, in particular on a weak anionic resin.

Preferably, the DCP in step (i) is a whey having a dry matter higher than or equal to 5.5%, more preferably the step (iii) is carried out before the UF (ii) and onto DCP (i).

Advantageously, this step (iii) enables to reach a demineralization rate higher than or equal to 90%.

In general, during an electrodialysis, the dissolved, mineral or organic, ionised species, such as salts, acids or bases, are transported through ionic membranes under the action of an electric current. An electrodialysis unit may include cationic membranes (membranes permeable to cations) CEC and/or anionic membranes (permeable to anions) AME placed in parallel and alternating. Under the action of the electric field applied using an anode and a cathode, the CME block the anions and allow the cations to pass, whereas the AME block the cations and allow anions to pass. Concentration compartments (concentrates) and desalination compartments are then created. This most common type of electrodialysis is an electrodialysis for which the base unit cell includes two compartments. The unit cell includes, as smallest repetition pattern, concentration and desalination operations (a compartment corresponding to a concentration or to a desalination). The solutions are renewed in the compartments by a circulation parallel to the plane of the membranes. The application of a current is ensured by two electrodes parallel to the plane of the membranes and placed at the ends of the electrodialyser.

In a ninth embodiment, the method includes a step, taking place after step iv), including at least one pass including a percolation over an absorbent resin.

The pass is carried out over at least one column of adsorbent resin.

Advantageously, this provision removes the colour of the processed UF permeate, in particular riboflavin (vitamin B2).

The absorbent resin may be functionalised.

The absorbent resin is preferably a resin of porosity between 10 Å and 1000 Å (angstrom), in particular absorbing small organic molecules.

In a tenth embodiment, the method includes a step (v) of nanofiltration carried out after step (iv) of processing on ion-exchange resins.

The nanofiltration step (v) can be carried out after or before the processing on an absorbent resin, preferably after the processing on an absorbent resin.

This nanofiltration step (v) is carried out in order to remove the various saccharides from the lactose, in particular the monosaccharides such as galactose.

This nanofiltration step (v) can be implemented when the dry mass fraction of the galactose with respect to the total dry mass of the lactose-rich liquid composition obtained at the end of step (iv) is greater than or equal to 1%, in particular less than or equal to 15%. This dry mass fraction of galactose may be encountered in the processing of certain acid wheys.

The nanofiltration membrane or membranes preferably have a cut-off threshold greater than or equal to 150 Daltons and less than or equal to 350 Daltons.

Advantageously, the lactose-rich liquid composition obtained after nanofiltration step (v) includes a dry mass fraction of lactose with respect to its total dry mass greater than or equal to 98% or 99%.

In an eleventh embodiment, the ratio of the dry mass of sugar(s), in particular lactose, over the total dry mass of the resulting lactose-rich liquid composition is greater than or equal to approximately 90%, preferably greater than or equal to 95%.

This ratio can be greater than or equal to 96%, 97%, 98% or even 99%. When this ratio is greater than or equal to 99%, the lactose-rich liquid composition can be used as edible lactose or as refined lactose.

It is the lactose-rich liquid composition obtained after step iv) or nanofiltration step v).

In a twelfth embodiment, the method includes a step of concentration by evaporation (in particular of the water contained in the lactose-rich liquid composition) and of drying carried out after the step of processing on the ion-exchange resins iv) in order to obtain sugar(s), in particular lactose, in solid form.

This step of transforming the lactose-rich liquid composition into solid can be carried out directly after step iv), or after the processing over an absorbent resin and/or after step v).

In an embodiment, the lactose-rich liquid composition undergoes a step of concentration by evaporation, then a step of drying and atomisation, in particular in an atomisation tower, for the production of powdered lactose.

Advantageously, the liquid composition obtained being very rich in lactose, enables the production of lactose without passing through a whey plant. This provision enables a whey producer to reclaim the whey without investing in a whey plant which generates large volumes of crystallisation mother liquor which is very difficult to reclaim.

In a thirteenth embodiment, the method includes a step iii) of demineralisation carried out before the ultrafiltration step (ii), and the at least partially demineralised ultrafiltration retentate obtained at the end of ultrafiltration step (ii) is stable at a temperature higher than or equal to 100° C.

The proteins of the ultrafiltration retentate are preferably stable at a temperature higher than or equal to 100° C., higher than or equal to 110° C., in particular higher than or equal to 120° C. or 130° C., for at least 1 minute, preferably for at least 5 minutes, more preferably for at least 10 minutes, in particular for at least 20 minutes.

The ultrafiltration retentate (ii) preferably has a pH adjusted to a pH higher than or equal to 6.5, in particular higher than or equal to 7.0.

In a fourteenth embodiment, the ratio of the dry mass of the total nitrogenous matter (TNM) over the total dry mass of the ultrafiltration retentate obtained in step (ii) is greater than or equal to approximately 50%, preferably greater than or equal to 60% or 70% or 80% or 90%.

In a fifteenth embodiment, the ratio of the dry mass of ash over the total dry mass of the ultrafiltration retentate obtained in step (ii) is less than approximately 6%, in particular less than or equal to approximately 5%.

This ratio is preferably less than or equal to 4%, more preferably less than or equal to 3%.

In a fifteenth alternative, the dairy protein composition of step (i) is chosen among: milk, in particular skimmed milk, whey and a mixture thereof.

In a sixteenth alternative, the dairy protein composition of step (i) is chosen among: an acid whey, a sweet whey, a native whey and a mixture thereof.

The embodiments and alternatives 1 to 16 mentioned above can be independently combined with one another, unless otherwise specified.

The object of the present disclosure, according to a second aspect, is a lactose-rich liquid composition that can be obtained by the method with reference to the first aspect of the disclosure according to any one of alternative embodiments 1 to 16.

In an alternative, the ratio of the total dry mass of sugar(s), in particular lactose, over the total dry mass of the lactose-rich liquid composition, is greater than or equal to 90%, preferably greater than or equal to 95%, more preferably greater than or equal to 96% or 97% or 98% or 99%.

An object of the present disclosure, according to a third aspect, is a facility for implementing the method for processing a dairy protein composition in order to obtain a lactose-rich liquid composition, in particular according to any one of the alternative embodiments with reference to the first aspect of the disclosure, including, in particular in series:
a—an ultrafiltration unit including a first inlet for receiving a dairy protein composition, a first outlet for an ultrafiltration permeate, and second outlet for an ultrafiltration retentate;
b—a demineralisation unit for at least partial demineralisation of the dairy protein composition upstream of the ultrafiltration unit, and/or a demineralisation unit for at least partial demineralisation of the ultrafiltration permeate, downstream of the ultrafiltration unit;
c—a processing unit including ion-exchange resins, downstream of the ultrafiltration unit for demineralising the ultrafiltration permeate which is at least partially demineralised beforehand, the unit including:
   at least one column A including a cationic resin and including a first inlet intended to receive the ultrafiltration permeate which is at least partially demineralised beforehand, and a first outlet for the at least partially demineralised ultrafiltration permeate P1,
   at least one column B including an anionic resin and including a first inlet for receiving the ultrafiltration permeate P1, and a first outlet for the at least partially demineralised ultrafiltration permeate P2.

In an embodiment, the ultrafiltration unit includes a concentration subunit for increasing the dry mass fraction of the dairy protein composition (as defined in the present text) and a diafiltration subunit downstream of the concentration subunit.

In an embodiment, the ultrafiltration unit, in particular the diafiltration unit, includes one or more ultrafiltration membranes, each having a minimum cut-off threshold greater than or equal to approximately 1000 Daltons, preferably greater than or equal to approximately 3000 Daltons, more preferably greater than or equal to 4000 Daltons.

The ultrafiltration unit, in particular the diafiltration unit, preferably includes one or more ultrafiltration membranes, each having a minimum cut-off threshold less than or equal to approximately 10,000 Daltons, preferably less than or equal to approximately 8000 Daltons, more preferably less than or equal to 7000 Daltons, preferentially less than or equal to 6000 Daltons.

The ultrafiltration unit enables the implementation of step (ii).

In an embodiment, the processing unit includes ion-exchange resins having at least one chain including, in particular in series, at least one column including a (strong or weak) cationic resin, preferably strong, followed by at least one column including a (strong or weak) anionic resin, preferably weak.

The processing unit includes ion-exchange resins enabling the performance of step (iv).

In an embodiment, the demineralisation unit includes an electrodialyser having cells including two compartments.

In an embodiment, the demineralisation unit includes, in particular in series:
an electrodialyser having cells including three compartments, preferably each cell includes a central compartment in which the product to be processed (dairy protein composition/ultrafiltration permeate) circulates, the central compartment is delimited between membranes for exchange of (monovalent and/or divalent) cations, in particular it is an, in particular exclusively, cationic substitution as described above;
optionally, an electrodialyser having cells including two compartments, and
an electrodialyser having cells including three compartments, preferably each cell includes a central compartment in which the product to be processed (dairy protein composition/ultrafiltration permeate) circulates, the central compartment is delimited between membranes for exchange of (monovalent and/or divalent) anions, in particular it is an, in particular exclusively, anionic substitution as described above.

In an embodiment, the demineralisation unit includes, in particular in series:
at least one column including an, in particular weak or carboxylic, cationic resin and
at least one column including an, in particular strong, anionic resin, optionally mixed with an, in particular strong, cationic resin (in other words with mixed beds); and
optionally a nanofiltration unit or an electrodialyser having cells including two compartments.

The demineralisation unit enables the implementation of step (iii).

In an embodiment, the facility includes a processing unit including an absorbent resin, in particular downstream of the processing unit including ion-exchange resins c).

In an embodiment, the facility includes a nanofiltration unit, in particular downstream of the processing unit including ion-exchange resins c), in particular likewise downstream or upstream of the processing unit including an absorbent resin.

The alternatives, embodiments and definitions according to a first aspect can be combined, independently of one another, and optionally with the alternatives and embodiments according to the second or third aspect of the disclosure.

The present disclosure makes it possible to advantageously obtain a lactose-rich liquid composition which can be ready to use directly or via a transformation step, in simple solid form not requiring treatment by crystallisation.

### BRIEF DESCRIPTION OF THE FIGURES

The disclosure will be better understood upon reading the following description of an embodiment of the disclosure, given solely as non-limiting example and with reference to the attached drawings, wherein:

FIG. 1 illustrates the method for processing a dairy protein composition according to the disclosure;

FIG. 2 illustrates the processing of the ultrafiltration permeate of FIG. 1 on ion-exchange resins, step (iv).

### DETAILED DESCRIPTION

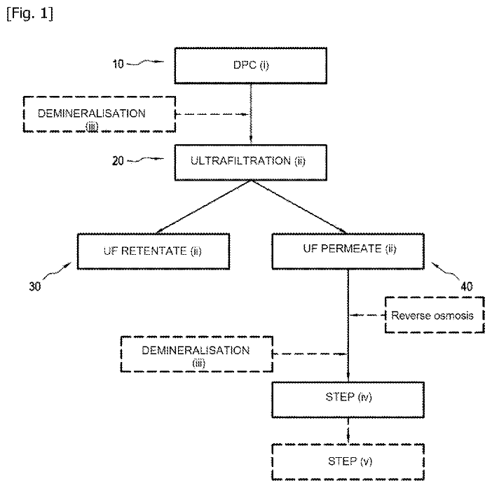

In FIG. 1, the dairy protein composition 10 is fed to an ultrafiltration unit 20, in particular including a concentration subunit and a diafiltration subunit, for forming a UF retentate 30 rich in serum proteins and a UF permeate 40 rich in lactose. In this example, the UF membranes have precisely one cut-off level between 1000 Daltons and 10000 Daltons, preferably between 4000 and 6000 Daltons.

The dairy protein composition (DPC) 10 can be at least partially demineralised during a demineralisation step (iii) before ultrafiltration step (ii).

The UF permeate 40 obtained in step (ii) can be demineralised, as an alternative to the demineralisation step taking place before UF step (ii) or in addition thereto, during a demineralisation step (iii) taking place after UF step (ii) and before step (iv) on the ion-exchange resins in order to achieve a satisfactory level of demineralisation enabling the recovery of a lactose-rich liquid composition after step iv), for which, in particular, the dry mass fraction of sugar(s), in particular of lactose, with respect to its total dry mass is greater than or equal to 90%.

The method according to the disclosure can also include a reverse osmosis step in order to increase the dry mass fraction of the UF permeate (ii), preferably carried out after a demineralisation step (iii).

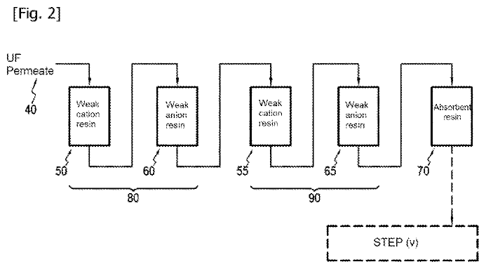

The UF permeate 40 is percolated as illustrated in FIG. 2 on columns including ion-exchange resins, in particular in two passes 80 and 90. During the first pass 80, the partially demineralised UF permeate 40 is percolated over a column including a, preferably strong, cationic resin 50, then is percolated over a column including a, preferably weak, anionic resin 60. During the second pass, the partially demineralised UF permeate 40 leaving the first pass 80, is again percolated over a column including a, preferably strong, cationic resin 55, then on a column including a, preferably weak, anionic resin 65. The UF permeate 40 leaving the two passes 80 and 90 can also undergo a percolation over a column including an absorbent resin 70 in order to remove the colouring of the UF permeate 40, in particular to remove the riboflavin responsible for the colouring. This step does not significantly change the mass fraction of lactose.

The absorbent resin can be, for example, an absorbent resin with a highly porous styrene divinyl benzene matrix with sulfonic groups, the pore size of which is greater than or equal to 350 Å, and having an exchange capacity of order 1.

A lactose-rich liquid composition is recovered at the end of step iv) and in this specific example after the processing on an absorbent resin. This lactose-rich and generally sugar-rich liquid composition has a very large mass fraction of lactose with respect to its total dry mass. In certain cases, this composition can further include galactose, depending on the initial dairy protein composition. The lactose-rich liquid composition then undergoes a nanofiltration step v) in order to remove or reduce the mass fraction of galactose, and thus increasing the mass fraction of lactose. This nanofiltration step v) can take place after the processing on the absorbent resin.

The strong cationic resins 50 and 55 can be, for example, porous strong styrene cationic resins, the bead size of which is 0.45 mm minimum, the water content of which is less than or equal to 58% and the exchange capacity 1.8 eq/I. It may be a resin supplied by the companies Mitsubishi, Dao, or Purolite.

The weak anionic resins 60 and 65 can be, for example, porous weak styrene anionic resins, the bead size of which is 0.40 mm minimum, the water content of which is less than or equal to 58% and the exchange capacity 1.6 eq/I minimum.

The dairy protein composition can be a sweet whey, an acid whey, or a native whey.

The dairy protein composition can the milk, in particular skimmed milk. In this case, the ultrafiltration retentate 40 in step (ii) is rich in serum proteins and in caseins.

In non-limited examples, a strong cationic resin, in particular suitable to carry out the step (iv), may be sold by Mitsubishi or Dow or Purolite, in particular is of Relite RPS type, or FPC22 type, or PPC150S type.

In non-limited examples, a weak anionic resin, in particular suitable to carry out the step (iv), may be sold by Mitsubishi or Dow or Purolite, in particular is of RAM1S type, or FPA54 type or A133S type.

In non-limited examples, an adsorbent resin, in particular suitable to carry out the present method, may be sold by Mitsubishi or Dow or Purolite, in particular is of Relite RAD/F type, or MN500 type.

### Example 1 According to the Disclosure for Processing an Acid Whey with a Partial Demineralisation (iii) Before UF Step (ii)

a The acid whey of step i) has undergone a demineralisation step (iii) before ultrafiltration step (ii). The partially demineralised acid whey, at the inlet to ultrafiltration step (ii), has a pH of approximately 6; a conductivity less than or equal to 5 mS/cm, a level of demineralisation of 74%, a dry mass extract of approximately 18%, a dry mass fraction of TNM of approximately 13%, a mass fraction of ash of approximately 2%, a dry mass fraction of lactose of order 86%, a mass fraction of cations (Na⁺, K⁺, NH₄⁺, Mg²⁺, Ca²⁺) less than or equal to 1.5%, and a mass fraction of anions (CI⁻, NO₃⁻, PO₄³⁻, SO₄²⁻) less than or equal to 0.5%.

This partially demineralised acid whey undergoes a UF step ii), then the UF permeate obtained is percolated on ion-exchange resins in step iv). The feed pressure of the whey during the UF in step ii) is of order 4 bars. The temperature of the partially demineralised whey at the inlet to UF step (ii) is of order 10° C., this temperature is maintained during UF step ii) and during step iv) on the ion-exchange resins. The preceding mass fractions are calculated with respect to the total dry mass of the partially demineralised acid whey at the inlet to UF step (ii).

b The UF permeate of the partially demineralised acid whey obtained at the outlet of the UF step (ii) has a pH of approximately 6; a dry mass extract of approximately 13%, a conductivity less than or equal to 2 mS/cm, a dry mass fraction of TNM of approximately 4%, a mass fraction of ash less than 2%, a mass fraction of cations (Na⁺, K⁺, NH₄⁺, Mg²⁺, Ca²⁺) less than or equal to 0.9%, a mass fraction of anions (Cl⁻, NO₃⁻, PO₄³⁻, SO₄²⁻) less than or equal to 0.2%, and a mass fraction of lactose of order 93%. The preceding mass fractions are calculated with respect to the total dry mass of the UF permeate at the outlet of UF step (ii).

c The UF retentate of the partially demineralised acid whey obtained at the outlet of UF step (ii), has a pH of between 5.5 and 5.9; a dry mass extract of approximately 15%, a dry mass fraction of TNM of approximately 50%, a mass fraction of ash less than approximately 2.8%, a mass fraction of cations (Na⁺, K⁺, NH₄⁺, Mg²⁺, Ca²⁺) less than or equal to 1.5%, a mass fraction of anions (Cl⁻, NO₃⁻, PO₄³⁻, SO₄²⁻) less than or equal to 0.3%, and a mass fraction of lactose of order 50%. The preceding mass fractions are calculated with respect to the total dry mass of the UF retentate at the outlet of UF step (ii).

d After a double pass over the ion-exchange resins of the UF permeate during step (iv), such as the double pass 80, 90, the lactose-rich liquid composition that is recovered after step iv), and optionally the passage over at least one column of absorbent resin, has a pH of order 6.8, a dry mass extract of approximately 10%, a conductivity less than or equal to 10 μS/cm, a dry mass fraction of TNM less than approximately 0.3%, a mass fraction of ash less than or equal to 0.1%, a mass fraction of cations (Na⁺, K⁺, NH₄⁺, Mg²⁺, Ca²⁺) less than or equal to 0.001%, and a mass fraction of anions (Cl⁻, NO₃⁻, PO₄³⁻, SO₄²⁻) less than or equal to 0.001%, and a mass fraction of lactose of order 99.5%. The preceding mass fractions are calculated with respect to the total dry mass of the lactose-rich liquid composition obtained.

### Example 2 According to the Disclosure for Processing a Sweet Whey with a Partial Demineralisation (iii) Before UF Step (ii)

a—The sweet whey of step i) has undergone a demineralisation step (iii) before ultrafiltration step (ii). The partially demineralised sweet whey at the inlet of ultrafiltration step (ii) and used hereafter has a pH of 6.8; a level of demineralisation of 90%, a dry mass extract of approximately 20%, a dry mass fraction of TNM of approximately 13%, a mass fraction of non-protein nitrogenous matter less than 2%, a mass fraction of ash of approximately 1%, a mass fraction of lactose of 80%. The preceding mass fractions are calculated with respect to the total dry mass of the partially demineralised sweet whey at the inlet to UF step (ii).

This partially demineralised sweet whey undergoes a UF step ii), then the UF permeate obtained is percolated on ion-exchange resins in step iv). The feed pressure of the whey during the UF in step ii) is of order 4 bars. The temperature of the partially demineralised whey at the inlet to UF step (ii) is of order 10° C., this temperature is maintained during UF step ii) and during step iv) on the ion-exchange resins.

b—The UF permeate of the partially demineralised acid whey obtained at the outlet of UF step (ii), has a pH of approximately 6.5; a dry mass extract of approximately 13%, a conductivity of order 600 μS/cm, a dry mass fraction of TNM of approximately 1%, a mass fraction of non-protein nitrogenous matter less than 1%, a mass fraction of ash less than or equal to 0.6%, a mass fraction of cations (Na⁺, K⁺, NH₄⁺, Mg²⁺, Ca²⁺) less than or equal to 0.3%, a mass fraction of anions (Cl⁻, NO₃⁻, PO₄³⁻, SO₄²⁻) less than or equal to 0.1%, and a mass fraction of lactose of 91%. The level of demineralisation of the UF permeate is of order 99%. The preceding mass fractions are calculated with respect to the total dry mass of the UF permeate at the outlet of UF step (ii).

c—The UF retentate of the partially demineralised sweet whey obtained at the outlet of UF step (ii) has a pH less than or equal to 7; a dry mass extract of approximately 20%, a dry mass fraction of the TNM of approximately 50%, a mass fraction of non-protein nitrogenous matter less than or equal to 5%, a mass fraction of ash less than or equal to approximately 0.5%. The preceding mass fractions are calculated with respect to the total dry mass of the UF retentate at the outlet of UF step (ii).

d—After a double pass over the ion-exchange resins of the UF permeate, such as the double pass 80, 90, the lactose-rich liquid composition obtained after step iv), and optionally the passage over at least one column of absorbent resin, has a pH of between 5 and 6, a dry mass extract of approximately 13%, a conductivity less than or equal to 5 μS/cm, a dry mass fraction of TNM less than approximately 0.4%, a mass fraction of non-protein nitrogenous matter less than or equal to 0.1%, a mass fraction of ash less than or equal to 0.1%, a mass fraction of cations (Na⁺, K⁺, NH₄⁺, Mg²⁺, Ca²⁺) less than or equal to 0.012%, and a mass fraction of anions (Cl⁻, NO₃⁻, PO₄³⁻, SO₄²⁻) less than or equal to 0.015%, and a mass fraction of lactose of order 99.8%. After a single pass over the resins 80, the mass fraction of lactose is of order 99%, which is less than the value of 99.8% obtained after a double pass. The level of removal of glycomacropeptides and riboflavin is close to 100%. The preceding mass fractions are calculated with respect to the total dry mass of the lactose-rich liquid composition obtained.

### Example 3 According to the Disclosure for Processing a Native Whey with a Demineralisation (iii) After UF Step (ii)

a—A native whey (step i) undergoes an ultrafiltration step (ii) then reverse osmosis to preconcentrate it. The ultrafiltration permeate of the preconcentrated native whey has a pH of 6.0; a conductivity less than or equal to 10.5 mS/cm, a dry mass extract of approximately 15%, a dry mass fraction of TNM of approximately 3%, a mass fraction of ash of approximately 9%, a dry mass fraction of lactose of order 84%, a mass fraction of cations (Na⁺, K⁺, Mg²⁺, Ca²⁺) calculated with respect to the total dry mass less than or equal to 3.6%, and a mass fraction of anions (CI⁻, P—PO₄³⁻, S—SO₄²⁻) less than or equal to 2.3%. This ultrafiltration permeate (40) undergoes a demineralisation step (iii) by electrodialysis iii) (the cells of which include two compartments), then is percolated on ion-exchange resins in step iv). The temperature of the ultrafiltration permeate during electrodialysis step (iii) is of order 30° C., this temperature is lowered to 10° C. during step iv) on the ion-exchange resins. The preceding mass fractions are calculated with respect to the total dry mass of ultrafiltration permeate at the inlet of demineralisation step (iii).

b The UF permeate of the partially demineralised native whey obtained at the outlet of electrodialysis step (iii) has a pH of approximately 5; a dry mass extract of approximately 14%, a conductivity less than or equal to 0.4 mS/cm, a dry mass fraction of TNM of approximately 2%, a mass fraction of ash less than 1%, a mass fraction of cations (Na⁺, K⁺, Mg²⁺, Ca²⁺) less than or equal to 0.13%, a mass fraction of anions (CI⁻, P—PO₄³⁻, S—SO₄²) less than or equal to 0.27%, and a dry mass fraction of lactose of order 97%. The level of demineralisation of the UF permeate after step (iii) is of order 96%. The preceding mass fractions are calculated with respect to the total dry mass of the UF permeate at the outlet of demineralisation step (iii).

c—After a double pass over the ion-exchange resins of the UF permeate during step (iv), such as the double pass 80, 90, the lactose-rich liquid composition obtained after step iv), and optionally the passage over at least one column of absorbent resin, has a pH of order 5, a dry mass extract of approximately 13%, a conductivity less than or equal to 5 μmS/cm, a dry mass fraction of TNM less than approximately 0.8%, a mass fraction of ash less than or equal to 0.1%, a mass fraction of cations (Na⁺, K⁺, Mg²⁺, Ca²⁺) less than or equal to 0.001%, and a mass fraction of anions (Cl⁻, PO₄³⁻, SO₄²) less than or equal to 0.001%, and a dry mass fraction of lactose of order 99.5%. The preceding mass fractions are calculated with respect to the total dry mass of the lactose-rich liquid composition obtained.

### Example 4 According to the Disclosure for Processing a Native Whey with a Demineralisation (iii) After UF Step (ii)

a—The native whey (i) undergoes an ultrafiltration step (ii) and reverse osmosis in order to preconcentrate it. The ultrafiltration permeate of the preconcentrated native whey has a pH of approximately 6; a conductivity less than or equal to 10.5 mS/cm, a dry mass extract of approximately 17%, a dry mass fraction of TNM of approximately 3%, a mass fraction of ash of approximately 9%, a dry mass fraction of lactose of order 84%, a mass fraction of cations (Na⁺, K⁺, Mg²⁺, Ca²⁺) calculated with respect to the total dry mass less than or equal to 3.6%, and a mass fraction of anions (Cl⁻, P—PO₄³⁻, S—SO₄²⁻) less than or equal to 2.3%. This ultrafiltration permeate (40) undergoes a demineralisation step by acid electrodialysis iii) and is then percolated on ion-exchange resins in step iv). The demineralisation step iii) includes a chain of three electrodialyses: cation substitution electrodialysis (CSE) of cations by hydrogen ions H⁺ (iiia) in three compartments, followed by an electrodialysis with two demineralisation compartments, and followed by an anion substitution electrodialysis (ASE) of anions by hydroxyl ions (iiib) in three compartments. The temperature of the ultrafiltration permeate during electrodialysis step (iii) is of order 30° C., this temperature is lowered to 10° C. during step iv) on the ion-exchange resins. The preceding mass fractions are calculated with respect to the total dry mass of ultrafiltration permeate at the inlet of demineralisation step (iii).

b—The UF permeate of the whey undergoes a first CSE electrodialysis (iiia) that enables substituting of the cations by protons and thus working in an acid process. The whey at the outlet of the CSE (iiia), has a pH of approximately 1.5; a dry mass extract of approximately 16%, a conductivity of approximately 12 mS/cm, a dry mass fraction of TNM of approximately 2%, a mass fraction of cations (Na⁺, K⁺, Mg²⁺, Ca²⁺) less than or equal to 0.8%, a mass fraction of anions (Cl⁻, P—PO₄³⁻, SO₄²⁻) less than or equal to 1.9%, and a mass fraction of lactose of order 95%. The acidified whey then undergoes a demineralisation of approximately 90% by conventional electrodialysis ED with two compartments. The whey at the outlet of ED has a pH of approximately 2.6; a dry mass extract of approximately 16%, a conductivity of approximately 1 mS/cm, a dry mass fraction of TNM of approximately 2%, a mass fraction of cations (Na⁺, K⁺, Mg²⁺, Ca²⁺) less than or equal to 0.13%, a mass fraction of anions (Cl⁻, P—PO₄³⁻, SO₄²⁻) less than or equal to 0.19%, and a dry mass fraction of lactose of order 97%. The partially demineralised whey then undergoes a demineralisation of approximately 96% by an anionic substitution electrodialysis ASE (iiib). The whey at the outlet of ASE (iiib) has a pH of approximately 8; a dry mass extract of approximately 16%, a conductivity of approximately 0.4 mS/cm, a dry mass fraction of TNM of approximately 2%, a mass fraction of cations (Na⁺, K⁺, Mg²⁺, Ca²⁺) less than or equal to 0.13%, a mass fraction of anions (Cl⁻, P—PO₄³⁻, SO₄²⁻) less than or equal to 0.15%, and a dry mass fraction of lactose of order 98%.

c—After a double pass over the ion-exchange resins of the UF permeate during step (iv), such as the double pass 80, 90, the lactose-rich liquid composition obtained after step iv), and optionally the passage over at least absorbent resin, has a pH of order 5, a dry mass extract of approximately 13%, a conductivity less than or equal to 5 μmS/cm, a dry mass fraction of TNM less than approximately 0.8%, a mass fraction of ash less than or equal to 0.1%, a mass fraction of cations (Na⁺, K⁺, Mg²⁺, Ca²⁺) less than or equal to 0.001%, and a mass fraction of anions (Cl⁻, PO₄³⁻, SO₄²⁻) less than or equal to 0.001%, and a dry mass fraction of lactose of order 99.5%. The preceding mass fractions are calculated with respect to the total dry mass of the lactose-rich liquid composition obtained.

Demineralisation step (iii) carried out in examples 1 and 2 can be any demineralisation step known to a person skilled in the art enabling demineralisation of the dairy protein composition at the inlet of UF step (ii) and/or after UF step (ii) in order to lower the dry mass fraction minerals of the UF permeate at the inlet of step (iv) including at least one pass over ion-exchange resins. This demineralisation step can be carried out in a non-limiting manner as described in the present text or again as described in patent EP 1.053.685 B1 or WO 2020/207894 or again as described in examples 3 and 4.

1. Method for processing a dairy protein composition in order to obtain a lactose-rich liquid composition, wherein the method comprises the steps:
(i) providing a dairy protein composition;
(ii) ultrafiltration of said dairy protein composition in order to obtain an ultrafiltration permeate and an ultrafiltration retentate;
(iii) a step of at least partial demineralisation, taking place one or more of before ultrafiltration step (ii) and after ultrafiltration step (ii);
(iv) one step of processing, on ion-exchange resins, said at least partially demineralised ultrafiltration permeate, comprising at least one pass comprising percolation over a cationic resin followed by percolation over an anionic resin.

2. Method according to claim 1, wherein step (iv) comprises at least two passes.

3. Method according to claim 1, wherein step (iv) of processing, on ion-exchange resins, the at least partially demineralised ultrafiltration permeate, comprises at least one pass comprising percolation over a strong cationic resin followed by percolation over a weak anionic resin.

4. Method according to claim 1, wherein the conductivity of the ultrafiltration permeate (ii) at the inlet to step (iv) is less than or equal to 3 mS/cm.

5. Method according to claim 1, wherein the ultrafiltration step (ii) comprises the use of one or more ultrafiltration membranes, each having a minimum cut-off threshold greater than or equal to 1000 Daltons and less than or equal to 10,000 Daltons.

6. Method according to claim 1, wherein the dairy protein composition at the inlet of ultrafiltration step (ii) has a level of demineralisation greater than or equal to 70%.

7. Method according to claim 1, wherein the ultrafiltration permeate at the inlet of processing step (iv) on the ion-exchange resins has a level of demineralisation greater than or equal to 80%.

8. Method according to claim 1, wherein the at least partial demineralisation step (iii) comprises a step (iiia) of substituting cations by hydrogen ions H⁺.

9. Method according to claim 8, wherein the cation substitution step (iiia) is an electrodialysis step of cationic substitution carried out on an electrodialyser comprising cells each comprising three compartments.

10. Method according to claim 8, wherein the demineralisation step (iii) comprises a step (iiib) of substituting anions by hydroxyl ions OH⁻, and wherein said step (iiib) is carried out on an electrodialyser comprising cells each comprising three compartments.

11. Method according to claim 1, wherein the at least partial demineralisation step (iii) comprises one or more of an electrodialysis step and a nanofiltration step.

12. Method according to claim 1, comprising a step taking place after step (iv), comprising at least one pass comprising a percolation over an absorbent resin.

13. Method according to claim 1, comprising a step (v) of nanofiltration carried out after the step (iv) of processing on ion-exchange resins.

14. Method according to claim 1, wherein the ratio of the dry mass of lactose over the total dry mass of the resulting lactose-rich liquid composition is greater than or equal to approximately 90%.

15. Method according to claim 1, comprising a step iii) of demineralisation carried out before the ultrafiltration step (ii), and wherein at least partially demineralised ultrafiltration retentate obtained at the end of ultrafiltration step (ii) is stable at a temperature higher than or equal to 100° C.

16. Method according to claim 1, wherein the ratio of the dry mass of the total nitrogenous matter (TNM) over the total dry mass of the ultrafiltration retentate obtained in step (ii) is greater than or equal to approximately 50%.

17. Method according to claim 1, wherein the ratio of the dry mass of ash over the total dry mass of the ultrafiltration retentate obtained in step (ii) is less than 6%.

18. Method according to claim 1, wherein the dairy protein composition of step (i) is chosen among: milk, in particular skimmed milk, whey and a mixture thereof.

19. Method according to claim 18, wherein the dairy protein composition is chosen among: acid whey, sweet whey, native whey and a mixture thereof.

20. Method according to claim 1, comprising a step of concentration by evaporation and drying, carried out after the step (iv) of processing on ion-exchange resins, in order to obtain lactose in solid form.

21. A lactose-rich liquid composition obtained by the method according to claim 1, wherein the ratio of the dry mass of lactose over the total dry mass of said lactose-rich liquid composition is greater than or equal to 90%.
